(19) United States
(12) Patent Application Publication
(10) Pub. No.: US 2003/0178823 A1
(43) Pub. Date: Sep. 25, 2003

(54) Side curtain typed airbag, and a process of preparing for the same

(76) Inventors: Kwang-Oh Kim, Kyongsangbuk-Do (KR); Sang-Mok Lee, Kyongsangbuk-Do (KR)

Correspondence Address: BIRCH STEWART KOLASCH & BIRCH, PO BOX 747, FALLS CHURCH, VA, 22040-0747, US

(21) Appl. No.: 10/362,428

(22) PCT Filed: Aug. 21, 2001
(86) PCT No.: PCT/KR01/01410

(30) Foreign Application Priority Data
Aug. 25, 2000 (KR) 2000/49440

(51) Int. Cl. B60R 21/22

(52) U.S. Cl. 280/730.2

(57) ABSTRACT

The present invention relates to a side curtain typed air bag in order to prevent passengers from being injured by a side glass window or structure of a vehicle in the event of a rollover or rolling of the vehicle. The side curtain typed air bag of the present invention is characterized in that it has an air leak amount per unit length of the sewing portions of less than 0.8 L/min-cm (measured at a pressure of 2.5 Kpa), and is prepared by a method in which a rubber component is coated on a synthetic fiber fabrics by using a concave knife so that a rubber coating layer is thicker in the sewing portions (1) than in the remaining portions (2) out of the sewing portions to prepare fabrics for air bag, of which sewing portions are sewn. The air bag of the present invention can be prepared without any separate sealing process and can safely protect passengers in the event of a rollover of the vehicle by supressing the air leak.

### TECHNICAL FIELD

The present invention relates to an air bag installed in a side glass window or structure of a vehicle (hereinafter, referred to as “a side curtain typed air bag”) in order to protect passengers against impact in the event of a side collision and to prevent them being bumped with a side glass window or structure of the vehicle, and a process of preparing the same.

In general, a rubber component such as silicone rubber, chloroprene rubber or the like is uniformly coated on fabrics, which is then cut and sewn to prepare an air bag. A common air bag installed at the front of a vehicle should be quickly inflated by an explosive gas in the event of a collision and then the gas in the inflated air bag should be discharged within a short time period in order to minimize the second impact of passenger applied by the inflated air bag and to ensure the driver's visual field. For this reason, vents for leaking air are provided in most of conventional air bags which are installed at the front of a vehicle.

Since a side curtain typed air bag is to protect passengers against side windows or structures of a vehicle in the event of a rollover or rolling of the vehicle, the inflation state of the side curtain typed air bag should be maintained during several seconds, more properly more than 5 seconds, when the vehicle is rolling in order to securely hold up the head of passengers. For this purpose, more gas than is necessary should not leak from fabrics and sewing portions of the inflated air bag.

### BACKGROUND ART

U.S. Pat. No. 5,685,347 proposes a method of weaving on a Jacquard loom the upper and lower fabrics simultaneously of an air bag in order to prevent too much air leaking from sewing portions of the air bag. However, this method has problems that it needs an Jacquard loom equipped with expensive electronic devices and it is very complicated to program or input weaving patterns into such loom.

Further, air bags prepared by this method also have problems that connecting portions of the fabrics are so weak that a gap is generated at the connecting portions when air bag is inflated and thus air leaks through the gap, and that the connecting portions are weak in strength.

In addition, Japanese laid-Open Publication Hei 4-81342, Hei 4-197848, Hei 3-10946 etc., propose methods of sealing an air bag, which comprise sewing the fabrics coated with a rubber component to prepare an air bag, and closing up the sewing portions of the air bag with tape. However, these methods have problems such that, since an additional sealing process is added, the process thereof becomes complicated and the production cost increases.

Meanwhile, proposed is a method of preparing a side curtain typed air bag by sewing fabrics coated with silicon rubber having a good hot-air stability to prepare an air bag. In such side curtain typed air bag in which sewing portions are not sealed, however, it has an air leak amount per unit length of sewing portions of about 0.9 L/min-cm (measured at a pressure of 2.5 KPa) and thus it cannot last its inflated state for more than 5 seconds. If there is a vent for leaking air in an air bag, the lasting period of the inflated state will further decrease.

### DISCLOSURE OF THE INVENTION

The present invention is to provide a side curtain typed air bag for preventing passengers being bumped with side glass windows, etc. of an vehicle, by suppressing air leak from an inflated air bag to maintain the inflated state for at least 5 seconds, even without any separate sealing process of sewing portions.

Further, the present invention is to provide a method of preparing a side curtain typed air bag, characterized by that synthetic fiber fabrics are coated with a rubber component by using a concave knife to prepare fabrics for preparing an air bag in which the rubber component is more thickly coated on the sewing portions (1) of the fabrics than the non-sewing portions (2) of the fabrics, and then sewing them.

Further, the present invention is to provide a method of preparing a side curtain typed air bag, in which the size of needle holes can be minimized when preparing an air bag since the rubber coating are thick at the sewing portions, and thereby, the air bag can maintain a lower air leak amount than conventional known air bags even without carrying out a separate sealing process on the sewing portions.

The side curtain typed air bag of the present invention, in which the upper and lower portions consisting of thermoplastic multi-filaments are sewn, is characterized in that it has an air leak amount per unit length of the sewing portions of less than 0.8 L/min-cm (measured at a pressure of 2.5 KPa).

The method of preparing a side curtain typed air bag of the present invention is characterized in that the air bag is prepared by sewing fabrics for preparing an air bag which is prepared by coating a rubber component on a synthetic fiber fabrics by using a concave knife so that a rubber coating layer is thicker in the sewing portions (1) of the fabrics than in the remaining portions (2) of the fabrics.

In below, the present invention is illustrated in details by referring the drawings attached.

First, in the present invention, fabrics for preparing a side curtain typed air bag is prepared by coating a rubber component on synthetic fiber fabrics by using a concave knife as shown in FIG. 3. In such case, it is possible to use polyamide fabrics, polyester fabrics or the like as the synthetic fiber fabrics, but it is more preferable to use polyamide fabrics having a warp and weft denier of 210˜420 denier.

Since an air bag of the present invention is mounted at the side of vehicles, it is preferable to have a less volume. Therefore, the synthetic fiber fabrics are preferably consist of warps and wefts of 210˜420 denier.

As to rubber components, it can include chloroprene rubber, silicone rubber, urethane rubber or the like. The coating amount of rubber component per unit area of the sewing portion (1 in FIG. 1) in an air bag is preferably 50˜200 g/m², and the coating amount of rubber component per unit area of the remaining portion (2 in FIG. 1) other than the sewing portion in an air bag is preferably more than 30 g/m².

When the coating amount of rubber component per unit area of the sewing portion (1 in FIG. 1) in an air bag is less than 50 g/m², a problem arises that the air leak amount increases since the size of the needle hole cannot be minimized. When the coating amount exceeds 200 g/m², problems arise that the sewing becomes difficult and the volume of the air bag increase.

Meanwhile, when the coating amount of rubber component per unit area of the remaining portion (2 in FIG. 1) other than the sewing portion in an air bag is less than 30 g/m², a problem arises that, when the air bag is in inflated, the inflating air can leak out through the fabrics, and as a result, the air bag cannot function in a proper manner.

In addition, for a smooth sewing and the minimization of the volume of an air bag, it is preferable to maintain the width of the rubber coating layer of sewing portions (1 in FIG. 1) of 1˜5 cm, preferable 1.5˜2.5 cm.

Then, a side curtain typed air bag as shown in FIG. 1 is prepared by cutting and sewing the above prepared fabrics for preparing air bags.

In the present invention, the air leak amount can be lowered even without any separate sealing process since the size of needle holes (3) can be minimized on preparing the air bag due to the thick rubber coating layer at the sewing portions. As a result, the air bag of the present invention has an air leak amount of less than 0.8 L/min-cm measured as a pressure of 2.5 KPa per unit length of sewing portions even without any separate sealing process of the sealing portions.

In the present invention, the air leak amount per unit length of sewing portions is determined by a measuring apparatus equipped with a regulator, a flow meter and a pressure meter.

Specifically, the leak test comprises inflating an air bag completely by introducing an air under the pressure of 2.5 KPa into an air bag, and measuring the amount (L) of air leaking from the air bag per unit period (1 minute), which is divided by total length (cm) of the sewing portions of the air bag to obtain the air leak amount per unit length of sewing portions. In the test, it is assumed that the air leak amount is zero (0 L) from fabrics of the air bag other than the sewing portions.

Therefore, the air bag of the present invention would protect passengers in a vehicle more effectively since it the inflating state of the air bag can be maintained for at least 5 minute in the event of a rollover or rolling of the vehicle. The air bag of the present invention does not contain any separate vent for leaking air.

### BRIEF DESCRIPTION OF THE DRAWINGS

FIG. 1 is a plane view of the side curtain type air bag fabrics according to the present invention.

FIG. 2 is a cross sectional view of the side curtain type air bag according to the present invention.

FIG. 3 is a front view of a coating knife used for the preparation of the air bag fabrics according to the present invention.

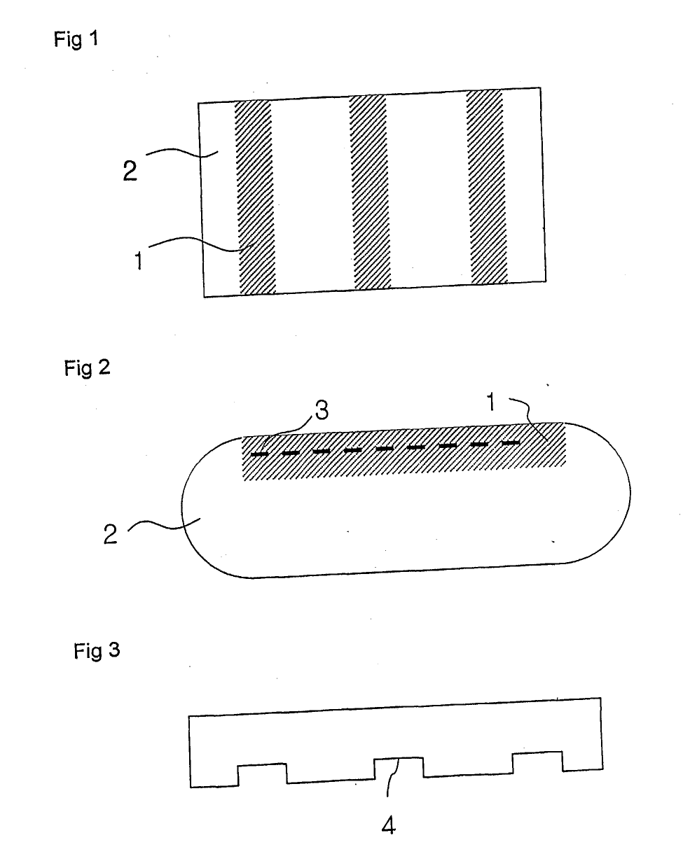

In the above drawings, symbol 1 represents thickly rubber-coated fabric portions (sewing portions), symbol 2 represents thinly rubber-coated fabrics portion (the remaining portion other than sewing portions), symbol 3 represents stitch (in sewing portions), and symbol 4 represents a concave portion of the coating knife.

### BEST MODE FOR CARRYING OUT THE INVENTION

The present invention will be more specifically illustrated by using the following Examples and Comparative Examples, but the present invention does not limited to these Examples.

### EXAMPLE 1

On fabrics (density: 70 filaments/inch ×70 filaments/inch) made from polyamide-66 fibers having warps and wefts of 210 denier, silicone rubber is coated by using a concave knife as shown in FIG. 3 to prepare fabrics for a side curtain typed air bag. The coating conditions are controlled such that the coating amount is to be 55 g/m² for the portions to be sewn when preparing an air bag (sewing portions) of the fabrics, and 35 g/m² for the portions not to be sewn (the remaining portions other than the sewing portions) of the fabrics. After cutting thus prepared air bag fabrics so that the thickly coated portions become sewing portions, the sewing portions are sewn to give a side curtain typed air bag. Thus prepared air bag has an air leak amount per unit length of sewing portions of the air bag of 0.46 L/min-cm, measured at a pressure of 2.5 KPa.

### EXAMPLE 2

On fabrics (density: 60 filaments/inch ×60 filaments/inch) made from polyamide-66 fibers having warps and wefts of 315 Denier, polyurethane rubber is coated by using a concave knife as shown in FIG. 3 to prepare fabrics for a side curtain typed air bag. The coating conditions are controlled such that the coating amount is to be 70 g/m² for the portions to be sewn when preparing an air bag (sewing portions) of the fabrics, and 55 g/m² for the portions not to be sewn (the remaining portions other than the sewing portions) of the fabrics. After cutting thus prepared air bag fabrics so that the thickly coated portions become sewing portions, the sewing portions are sewn to give a side curtain typed air bag. Thus prepared air bag has an air leak amount per unit length of sewing portions of the air bag of 0.40 L/min-cm, measured at a pressure of 2.5 KPa.

### EXAMPLE 3

On fabrics (density: 49 filaments/inch ×49 filaments/inch) made from polyamide-66 fibers having warps and wefts of 420 denier, chloroprene rubber is coated by using a concave knife as shown in FIG. 3 to prepare fabrics for a side curtain typed air bag. The coating conditions are controlled such that the coating amount is to be 65 g/m² for the portions to be sewn when preparing an air bag (sewing portions) of the fabrics, and 45 g/m² for the portions not to be sewn (the remaining portions other than the sewing portions) of the fabrics. After cutting thus prepared air bag fabrics so that the thickly coated portions become sewing portions, the sewing portions are sewn to give a side curtain typed air bag. Thus prepared air bag has an air leak amount per unit length of sewing portions of the air bag of 0.43 L/min-cm, measured at a pressure of 2.5 KPa.

### Comparative Example 1

On fabrics (density: 70 filaments/inch ×70 filaments/inch) made from polyamide-66 fibers having warps and wefts of 210 denier, silicone rubber is coated in a uniform coating amount of 35 g/m² thickness by using a conventional knife to prepare fabrics for a side curtain typed air bag. Thus prepared air bag fabrics are cut and sewn to give a side curtain typed air bag. Thus prepared air bag has an air leak amount per unit length of sewing portions of the air bag of 0.86 L/min-cm, measured at a pressure of 2.5 KPa.

### INDUSTRIAL APPLICABILITY

Since the side curtain typed air bag of the present invention can maintain its inflated state for at least 5 seconds, it is very useful as an air bag mounted in a side window or structure of a vehicle in order to protect passengers in the event of a rollover or rolling of the vehicle.

Further, since the portions to be sewn of the fabrics are thick, the air bag fabrics of the present invention can minimize the size of needle holes when sewing the fabrics to prepare an air bag. As a result, the air leak amount of the sewing portions can be lowered even without any separate sealing process. Therefore, the process of preparing a side curtain typed air bag is simplified and the production cost is low.

What is claimed is:

1. A side curtain typed air bag, in which the upper and lower portions consisting of thermoplastic multi-filaments are sewn, characterized in that it has an air leak amount per unit length of the sewing portions of less than 0.8 L/min-cm (measured at a pressure of 2.5 KPa).

2. The side curtain typed air bag according to claim 1, wherein the rubber component is more thickly coated on sewing portions (1) than the remaining potions (2) other than the sewing portions.

3. A method of preparing a side curtain typed air bag, characterized in that a rubber component is coated on a synthetic fiber fabrics by using a concave knife so that a rubber coating layer is thicker in the sewing portions (1) than in the remaining portions (2) out of the sewing portions to prepare fabrics for air bag, of which sewing portions are sewn.

4. The method according to claim 3, characterized in that the coating amount per unit area of sewing portions of the air bag is 50˜200 g/m².

5. The method according to claim 3, characterized in that the coating amount per unit area of the remaining portions (2) out of the sewing portions of the air bag is more than 30 g/m².

6. The method according to claim 3, characterized in that the width of the coating layer at the sewing portions (1) of the air bag is 1˜5 cm.

7. The method according to claim 3, characterized in that the width of the coating layer at the remaining portions (2) out of the sewing portions of the air bag is 1.5˜2.5 cm.

8. The method according to claim 3, characterized in that the rubber component is chloroprene rubber, silicone rubber or urethane rubber.
